(19) United States
(12) Patent Application Publication
(10) Pub. No.: US 2023/0080556 A1
(43) Pub. Date: Mar. 16, 2023

(54) A PROCESS FOR RECOVERING METALS FROM RECYCLED RECHARGEABLE BATTERIES

(71) Applicant: BROMINE COMPOUNDS LTD., Beer-Sheva (IL)

(72) Inventors: Or PRESS FRIMET, Lehavim (IL); Mohamad MASARWA, Lehavim (IL); Yaniv ENGLERT, Beer-Sheva (IL)

(21) Appl. No.: 17/799,238

(22) PCT Filed: Feb. 11, 2021
(86) PCT No.: PCT/IL2021/050168

§ 371 Date: Aug. 11, 2022

Related U.S. Application Data
(60) Provisional application No. 62/975,218, filed on Feb. 12, 2020.

(51) Int. Cl. C22B 26/12; H01M 10/54; C22B 7/00

(52) U.S. Cl. CPC C22B 26/12; H01M 10/54; C22B 7/007

(57) ABSTRACT

The invention relates to hydrometallurgical method for recovering lithium and one or more transition metals from spent lithium ion batteries, comprising: treating an electrode material of the batteries in an alkaline solution to dissolve lithium in said solution; separating from the alkaline solution a solid phase consisting of lithium-depleted electrode material; recovering lithium from said alkaline solution; leaching the lithium-depleted electrode material with an acid leach solution to dissolve one or more transition metals of the electrode material in the leach solution; separating insoluble material, if present, from the leach solution to obtain metal-bearing aqueous solution and isolating one or more transition metal(s) and optionally the remainder of the lithium from said metal-bearing aqueous solution.

The use of rechargeable batteries (especially lithium batteries) in various devices such as electric vehicles, mobile phones, mobile computers etc. is constantly increasing since they entered the market in the 1990s. Due to their extensive use, there exists a need for efficient methods to recover metals from spent lithium batteries. The negative electrode material in lithium-ion batteries consists of carbon/graphite (applied onto a current collector made of aluminum). The positive electrode material generally has the formula LiₓM_{y}O_{z}, where M stands for one or more transition metals; the lithium metal oxide is applied onto a current collector made of copper. The chief metal oxides that are most widely used to prepare the positive electrodes for lithium ion batteries include lithium cobalt oxide (LiCoO₂ or LCO), lithium manganese oxide (LiMn₂O₄ or LMO), lithium manganese nickel oxide (Li₂Mn₃NiO₈ or LMNO), lithium nickel manganese cobalt oxide (LiNiMnCoO₂ or NMC) and lithium nickel cobalt aluminum oxide (LiNiCoAlO₂ or NCA). Hence an effective recovery method should enable separation between lithium and the abovementioned transition metals.

Hydrometallurgical methods are well-suited to metal recovery from batteries and indeed leaching of metals from spent lithium-ion batteries, with the aid of various aqueous reagents, followed by selective precipitation of water-insoluble salts of the metals to accomplish metals recovery is known. For example, the use of concentrated hydrochloric acid was reported by Zhang et al. (Hydrometallurgy 47 p. 259-271 (1998)), showing the dissolution of lithium cobalt oxide in hydrochloric acid, separation of cobalt from the aqueous leach solution with solvent extraction using an extractant in kerosene, stripping of the cobalt from the cobalt-loaded organic medium and precipitation of lithium in the form of the carbonate salt from the aqueous phase.

A different approach towards recovery of precious metals from batteries was illustrated in Example 1 of WO 01/08245, where hydrochloric acid was used to leach the metals from cobalt-containing battery to produce the corresponding metal halides, following which sodium hydroxide was added to the solution, causing the precipitation of the transition metals in the form of the corresponding hydroxides. Lithium carbonate was subsequently isolated from the filtrate upon addition of sodium carbonate to precipitate lithium carbonate. However, to reach good leaching efficiency of the cathode material, hydrochloric acid would need the help of hydrogen peroxide to advance the dissolution of the cathode material by reducing Co³⁺ to Co²⁺ (dipositive cobalt dissolves readily). Addition of hydrogen peroxide that acts as a reductant is therefore needed to augment the leaching action of hydrochloric acid. See Freitas et al., Journal of Power Sources 171 p. 953-959 (2007) and also Lithium. Process Chemistry: Resources, Extraction, Batteries, and Recycling by Alexandre Chagnes and Jolanta Swiatowska page 245, Elsevier (2015), which discuss the addition of hydrogen peroxide as a reducing agent to various leaching media, including hydrochloric acid, as illustrated by the reaction equation below showing dissolution of LiCoO₂ cathode material:

2LiCoO₂+6HCl+H₂O₂ [symbol] 2CoCl₂+2LiCl+4H₂O+O₂ (1)

It has recently been shown in co-assigned patent application (PCT/IL2019/050882; WO 2020/031178) that hydrobromic acid has several advantages over hydrochloric acid in the hydrometallurgical processing of spent lithium-ion batteries. Hydrobromic acid achieves a higher yield of metal leaching as compared to hydrochloric acid. An appreciable difference between the two acids was noted in the case of manganese-containing cathode materials: the leachability of manganese is greatly improved with the use of hydrobromic acid. This point is of significance, bearing in mind the trend in the industry to switch to manganese-containing cathodes. Furthermore, hydrobromic acid accomplishes the leaching of cathode materials with good yield absent an auxiliary reducing agent such as hydrogen peroxide. Usually bromide is oxidizable by the metal ions that are present in the cathode materials of lithium-ion batteries. That is, metals in the cathode materials that exist in high oxidation states, e.g., the trivalent cations Co³⁺ and Mn³⁺/Mn⁴⁺, transform into the corresponding readily soluble divalent cations by gaining an electron from the bromide that is oxidized to generate elemental bromine.

The leaching methods specifically illustrated in the publications mentioned above, including the hydrobromic acid-based method of our earlier patent application PCT/IL2019/050882 (WO 2020/031178), share one major feature in common: the last metal to be recovered is lithium. That is, following the dissolution of the electrode material in an acid, the transition metals are successively removed by various techniques from the leaching solution, and eventually, a transition metals-depleted solution is treated with a carbonate source to precipitate Li₂CO₃.

We have now found that lithium is separable from the electrode material (e.g., from the powder known as ‘black mass’, containing the valuable metal constituents of the battery) before the acidic leaching reaction takes place, via treatment of the black mass in a strong alkaline environment (e.g., pH>12, and more preferably, pH>13). Treating the black mass in a solution of alkali hydroxide or ammonium hydroxide, e.g., under heating, results in the release of lithium from the black mass to the alkaline solution. In contrast, transition metals are generally insoluble under the alkaline conditions and remain in the black mass.

Owing to the preliminary treatment of the black mass in an alkaline environment, it is possible to remove a significant portion of the lithium contained in the black mass (˜40-70% of the total amount of lithium). The lithium-depleted black mass can then proceed to the next step, i.e., leaching with an acidic leach solution, especially hydrobromic acid, to recover other metals and the remaining lithium. In this way, the flexibility of the process is enhanced, reducing difficulties in isolation of the metals downstream to the acidic leaching.

It should be noted that hitherto, preliminary alkaline washes of the black mass were reported to result in the dissolution of aluminum only (aluminum serves as a current collector of the negative electrode in lithium ion batteries). See CN 101942568, CN 101942569, CN 107658521 and CN 104164568. For example, CN 104164568 illustrates addition of waste battery powder to 0.1M sodium hydroxide solution, whereby aluminum is solubilized and separated from the solid positive electrode material. The latter eventually undergoes leaching in sulfuric acid in the presence of hydrogen peroxide (which acts as a reductant, as previously described), whereby cobalt and lithium are dissolved and recovered, e.g., as Li₂CO₃. Aluminum recovery from the alkaline solution is achieved by pH adjustment, i.e., the pH is lowered because Al(OH)₃ forms a gelatinous precipitate in neutral or slightly alkaline water.

The present invention is therefore primarily directed to a hydrometallurgical method for recovering lithium and one or more transition metals from spent lithium ion batteries, comprising the steps of:

treating an electrode material of the batteries in an alkaline solution to dissolve lithium in said solution;

separating from the alkaline solution a solid phase consisting of lithium-depleted electrode material;

recovering lithium from said alkaline solution;

leaching the lithium-depleted electrode material with an acid leach solution to dissolve one or more transition metals of the electrode material in the leach solution;

separating insoluble material, if present, from the leach solution to obtain a metal-bearing aqueous solution and isolating one or more transition metal(s) and optionally the remainder of the lithium, from said metal-bearing aqueous solution.

Suitable feedstock of the process consists of electrode material in a particulate form that is recovered from spent lithium ion batteries by conventional industrial recycling processes. Electrode material, named ‘black mass’ in the industry, is isolated from battery cells following several treatment stages, depending on the type of technology utilized by the recycling industry. The methods by which the black mass is collected do not form part of this invention and need not be described in detail. For example, the black mass is recovered after A) discharged batteries are dismantled to remove auxiliary parts (plastic components, electronic components, cables, connectors) to recover the battery cells; and B) battery cells undergo a series of mechanical processing steps including crushing and grinding to obtain the electrode material in a particulate form. Other recycling technologies include A) disassembling the batteries to collect the electronic and plastic parts as above, B) pyrolysis of battery cells (known as vacuum thermal recycling) whereby batteries are deactivated and volatile organic electrolytes are removed due to evaporation and C) deactivated pyrolyzed cells undergo mechanical treatment (crushing, grinding and sorting) to collect a fine fraction consisting of the electrode powder. See, for example, Georgi-Maschler et al., Journal of Power Sources 207 p. 173-182 (2012), describing methods to recover the precious electrode material from lithium-ion batteries. Depending on the technology employed by the recycler, the feedstock may include, in addition of course to the cathode material (e.g., LiCoO₂, LiMn₂O₄, Li₂Mn₃NiO₈, LiNiMnCoO₂ and LiNiCoAlO₂) also the graphite anode material and aluminum and copper (the metals of which the current collector foils in the batteries are made of). Hereinafter, the terms “electrode material” and “black mass” are used interchangeably.

The alkaline solution used in the preliminary treatment of the black mass to separate lithium is preferably alkali hydroxide (e.g., sodium hydroxide), or ammonium hydroxide solution. Concentration of the alkali hydroxide in the solution may vary in the range from 1 to 45% by weight, e.g., from 10 to 20% by weight. Concentration of ammonium hydroxide in the solution may vary in the range from 5 to 25% by weight, e.g., from 10 to 25% by weight. Lithium is separable from the black mass under strongly alkaline conditions, e.g., pH>12.0, preferably pH>12.5, more preferably pH>13.0 and even pH>13.5.

As pointed out above, in contrast to the transition metals (Co, Mn, Ni) which are generally resistant to the alkaline treatment, aluminum will dissolve in a highly alkaline environment along with lithium, owing to the solubility of Al(OH)₄⁻ and LiOH, respectively. We have identified process variables that can be adjusted to increase the selectivity of the alkaline treatment towards lithium removal. In general, treating the black mass in an alkaline solution at room temperature or under moderate heating e.g., in the range from 20 to 80° C., especially from 20 to 70° C., e.g., from 20 to 60° C., (from 20 to 40° C. or from 30 to 70° C., depending on the alkaline solution), enhances the separability of lithium at the expense of aluminum. For example, treatment of the black mass in ammonium hydroxide solution in the range of 20 to 38° C., e.g., from 20 to 30° C. (at room temperature), results in higher lithium removal rates compared to aluminum. Experimental results reported below indicate that the yield of lithium removal may be about five times greater than the yield of aluminum removal. Treatment in alkali hydroxide across that temperature range leads to comparable lithium and aluminum removal rates (heating shifts the selectivity of the alkaline treatment in favor of aluminum).

Another useful approach to increase the degree of lithium separation from the black mass in the alkaline solution is by a pretreatment step to disrupt the black mass (presumably to free the lithium locked in the lattice of the mixed lithium-metal oxides) and render the lithium accessible to the solubilizing action of the alkaline solution. For example, we have found that the separability of lithium from the black mass is greatly improved if the black mass is exposed to a strongly acidic environment before alkaline treatment, e.g., by suspending the black mass in acidic environment, e.g., hydrochloric acid. The pretreatment serves the purpose of increasing the accessibility of the lithium locked in the black mass to the action of the alkaline agent in the next step. The concentration of the hydrochloric acid used in the pretreatment step may vary in the range from 5 to 30% by weight. For example, the black mass is stirred in the acid (solid/acid weight ratio is from 15/30 to 30/25) for at least 10 minutes, at room temperature.

To carry out the treatment in the alkaline solution, the black mass (either following the pretreatment step described above or not) is added to a reaction vessel that was previously charged with the alkaline solution, e.g., sodium hydroxide or ammonium hydroxide. Suitable solid/liquid ratio, namely, the proportion between the black mass and the aqueous alkaline solution is from 5/95 to 20/80, (usually from 10/90 to 15/85). Slow addition of the black mass is generally preferred, e.g., over a period of not less than 10 minutes, in a portion-wise manner, at the temperature range set out above. In the case where a pretreatment step is applied, then it may be more convenient to simply add the alkaline solution to the hydrochloric acid/black mass slurry to reach a strongly alkaline pH, rather than first separate the black mass from the HCl solution and add it to the base solution. Thus, in a variant of the invention, the pretreatment step is followed by basification with the alkaline solution, or separation of the solid electrode material and its addition to the alkaline solution.

The alkaline mixture is stirred for at least 2 hours to reach acceptable lithium dissolution rates to enable recovery of lithium from the alkaline solution, before proceeding with the leaching of the transition metals.

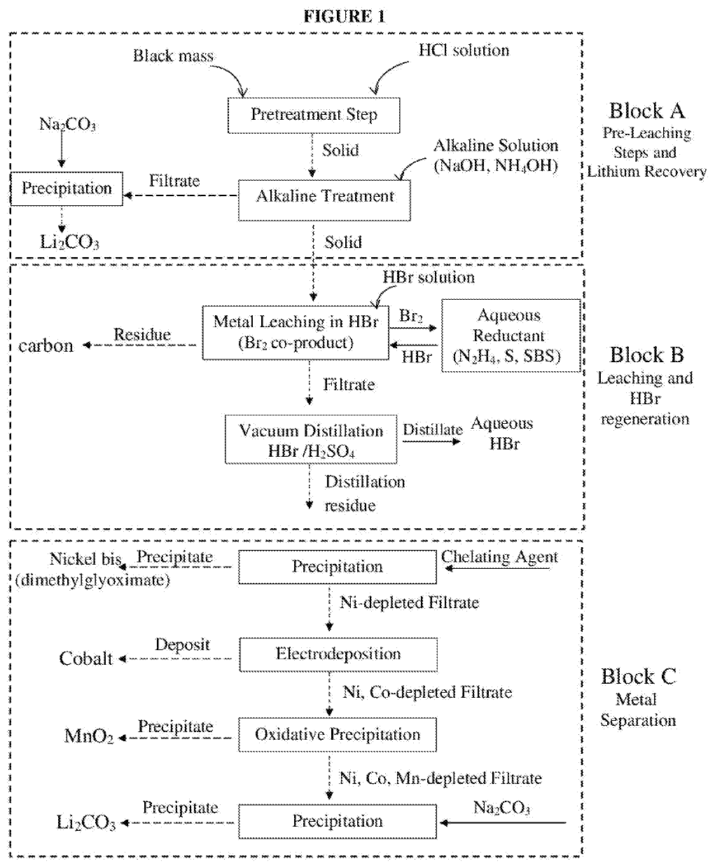

FIG. 1 is a flowchart illustrating one preferred variant of the process that consists of three major blocks:

Block A: pre-leaching steps to recover lithium; Block B: leaching in hydrobromic acid and HBr regeneration; and Block C: recovery of metals from the leach solution.

In FIG. 1, dashed arrows indicate solid/liquid separation, with the downwardly directed arrow showing the solid phase or the filtrate that proceeds to the next step.

It is seen that Block A in FIG. 1 includes the pretreatment step of the black mass (e.g., in acidic environment, to alter and disrupt the mixed oxides in the black mass) and the subsequent alkaline treatment as described above. Next, lithium-depleted black mass is separated from the solution, e.g., by filtration, or by any other solid/liquid separation technique such as decantation, etc. (however, as noted above, the separation step is not essential and the NaOH or NH₄OH solution may be fed to the black mass-containing acidic pretreatment solution directly). Lithium is conveniently isolated from the liquid phase, e.g., from the filtrate, by precipitation in the form of a water-soluble lithium carbonate. To this end, a precipitation reagent, namely, a carbonate source such as sodium carbonate is added to the solution. Another way is by bubbling CO₂ into the lithium hydroxide solution to form an insoluble lithium carbonate precipitate. It is worthy to note that lithium carbonate exhibits an abnormal solubility curve (solubility of lithium carbonate in water decreases with increasing temperature), hence precipitation may take place at a temperature up to 100° C. The precipitate is usually collected by filtration, washed and dried to obtain lithium carbonate with an acceptable purity.

The lithium-depleted black mass that was separated from the alkaline solution now proceeds to Block B, i.e., to the leaching step in an acidic leach solution. Hydrochloric acid and sulfuric acid can serve for this purpose, provided that a reducing agent such as hydrogen peroxide is also present in the leach solution. However, the most preferred acidic leach solution according to the invention comprises hydrobromic acid, because its action is achieved absent an added reductant. As explained above, bromide reduces trivalent transition metal cations such as Co³⁺ and Mn³⁺/Mn⁴⁺ to generate the divalent cations, which demonstrate higher water solubility and move from the black mass to the leachate. The bromide is simultaneously oxidized to elemental bromine. The present invention further provides a process design to enable recycling of elemental bromine evolved during the leaching back to the leaching reactor in the form of HBr, as explained in more detail below.

The leach solution used in the process therefore preferably consists of aqueous hydrobromic acid with HBr concentration varying in the range from 10 to ˜48 wt %, for example, from 15 to 48 wt %, e.g. 15-35 wt %. The loading of the black mass in the leach solution may be up to 35% wt %, e.g., from 7-35 wt %.

The solid collected after the alkaline treatment of Block A and the hydrobromic acid are introduced into a leaching reactor and a slurry is formed. For example, the solid can be first suspended in deionized water (about 1:1 weight ratio) and then hydrobromic acid is gradually added to the slurry. A suitable solid/liquid ratio, namely, the proportion between the leachable solid electrode material and the aqueous hydrobromic acid leach solution added to the leaching reactor is from 1/99 to 30/70; in case of a black mass, which contains a significant fraction of carbon, a lesser amount of leach solution is needed and the workable ratio is from 10/90 to 30/70. The reactor is equipped with agitation systems (e.g., mechanical) to enable continuous mixing of the slurry. Another requirement is that the reactor design includes a means for removal and absorption of the evaporated co-product, i.e., elemental bromine vapors.

The cathode material (e.g., LiCoO₂, LiMn₂O₄, Li₂Mn₃NiO₈, LiNiₓMn_{y}Co_{z}O₂, where X:Y:Z can be 1:1:1, 5:3:2, 6:2:2, or 8:1:1) dissolves gradually, usually with concomitant generation of elemental bromine. The dissolution time of the electrode material in the leach reactor increases with increasing solid/liquid ratio and decreases with increasing temperature and acid concentration. It is possible to achieve good leaching efficiencies for a variety of cathode materials during a reasonable time at room temperature, but it is generally preferred to perform the leaching under heating, e.g. from 40 to 90° C. For example, the temperature at the leaching reactor can be maintained at about 45 to 65° C., i.e., around the boiling point of elemental bromine. For example, the hydrobromic acid leach solution could be first heated to about 35-45° C., following which the slow addition of the black mass begins (or vice versa, acid is slowly added to the black mass/water slurry). On a laboratory scale, the addition time of the black mass lasts not less than 10 minutes. On completion of the addition the reaction mixture is heated to about 55° C.-60° C. Under these conditions, the leaching advances effectively and formation of Br₂ vapors is manageable. Br₂ is recyclable through reduction to HBr, e.g., with the aid of a reducing agent such N₂H₄, sulfur, NaHSO₃ and SO₂, either ex-situ following removal of bromine vapors from the leach reactor into an absorption medium, or in-situ in the leach reactor. Thus, the process of the invention comprises reducing the elemental bromine (Br₂) formed during the leaching, to generate HBr.

For example, the slurry in the leaching reactor is stripped with a suitable purge gas such as air or nitrogen; bromine vapors are discharged from the reactor by the outgoing gas stream. Vaporizing and expelling the free bromine is preferably achieved by blowing out with a current of air, such that bromine vapors are led to a suitable absorption medium. In one process variant illustrated in FIG. 1, the absorption medium consists of an aqueous solution of a reducing agent, to convert Br₂ into aqueous HBr, which is returned to the leach reactor.

Another way to recycle bromine formed during the leaching is through direct addition of a reducing agent to the leach reactor. For example, while hydrobromic acid is slowly added to the black mass/water slurry, a reducing agent is added under oxidation-reduction potential (ORP) control. The in-situ bromine evolving is manageable and its reduction to HBr proceeds efficiently.

For example, reduction of elemental bromine to HBr may be achieved with the aid of hydrazine. Hydrazine is a powerful reductant, which reacts with bromine according to the equation:

N₂H₄+2Br₂→N₂+4HBr (2)

Hydrazine is commercially available in an aqueous form, e.g., solution strength of 35%. For the purposes of this invention, 5 to 20% by weight aqueous hydrazine solutions can be used. The rate of hydrazine feeding to the leach reactor (during the gradual addition of HBr) is controlled by oxidation-reduction potential (ORP) measurements. We have found that adjusting the hydrazine addition rate to the leach reactor to maintain oxidizing environment in the range of +500 to +800 mV, e.g., 700 to 800 mV (ORP measured by platinum as the working electrode and Ag/AgCl as the reference electrode), enables the advancement of the leaching while effectively suppressing the escape of bromine vapors. Experimental results reported below indicate that operating within the ORP range mentioned above, hydrazine reduces Br₂ back to HBr while hydrazine itself has no negative effect on the leachability of the transition metals. The leaching may be carried out in a stirred reactor fitted with a dosage pump which delivers hydrazine to the reactor based on the ORP set point. Drop of redox values indicates the cessation of in-situ bromine formation and hence that the leaching process of the metal is close to an end.

Another example of a suitable reducing agent is sulfur, which reduces bromine in water. The reaction equation is:

3Br₂+1/8S₈+4H₂O→6HBr+H₂SO₄ (3)

More information about the preparation of hydrobromic acid from bromine and sulfur can be found, e.g., in U.S. Pat. No. 2,342,465. For example, sulfur may be supplied to the reaction as such, or by first preparing a solution of sulfur in elemental bromine and feeding the solution to the leach reactor.

Bisulfite, e.g., NaHSO₃ (SBS) can also be used to regenerate HBr in the leach reactor:

Br₂+NaHSO₃+H₂O→NaBr+HBr+H₂SO₄ (4)

As shown in the experimental work below, bisulfite can be added under ORP control, without altering the leaching efficiency.

Another way to reduce bromine to hydrobromic acid is by the reaction of bromine with sulfur dioxide and water. Sulfur dioxide, SO₂, may be bubbled through the aqueous absorption medium to react with the bromine vapors that were expelled from the leach reactor:

Br₂SO₂2H₂O→2HBr+H₂SO₄ (5)

As pointed out earlier, the feedstock may be a mixture consisting of a cathode and anode (carbon). The latter remains as a solid residue in the leach solution. Cessation of the evolution of elemental bromine (with its characteristic red color) may indicate that the leaching reaction has reached completion or is about to end. But the progress of the leaching can also be determined by withdrawing samples from the leach solution to measure the concentration of the progressively dissolving metals and assess the leaching yield, for example, by inductively coupled plasma mass spectroscopy (ICP-MS).

Upon completion of the leaching operation, the content of the leaching reactor undergoes solid/liquid separation to remove insoluble material (graphite anode material and perhaps a remnant of the cathode material) and collect the filtrate, as shown in FIG. 1, Block B. The filtrate constitutes the metal-bearing solution, from which the precious metals (e.g., nickel, cobalt, manganese and the remainder of lithium) are isolable by a variety of methods.

However, prior to the separation of the metals, aqueous hydrobromic acid is recovered from the filtrate—see the last step in FIG. 1, Block B. That is, a step of HBr recovery from the HBr/H₂SO₄ aqueous mixture. Hydrobromic acid is separable from the HBr/H₂SO₄ mixture through distillation, see for example U.S. Pat. No. 2,342,465 and US 2019/0119111. The use of elemental sulfur, bisulfite or sulfur dioxide to reduce bromine results in the formation of an aqueous solution of hydrobromic acid and sulfuric acid, from which hydrobromic acid can be recovered (after adjustment of H₂SO₄ concentration as explained below). When Br₂ formed in the leaching step is reduced with hydrazine, sulfuric acid is not coproduced and H₂SO₄ is added in its entirety to the filtrate collected following the leaching. The composition of the solution subjected to distillation is such that the HBr concentration varies in the range from 10 to 48%, and the molar ratio HBr:H₂SO₄ is adjusted in the range from 1:0.5-1.5, e.g., 1: 0.7-1.3. For example, commercially available sulfuric acid solutions with strength varying from 20 to 96 w/w % could be used to adjust the composition of the HBr/H₂SO₄ mixture undergoing distillation.

Efficient recovery of aqueous hydrobromic acid with acceptable purity is achieved by distillation under reduced pressure (vacuum distillation), say, in the range from about 50-400 mmHg.

When a satisfactory pressure is attained in the distillation apparatus, e.g., using a vacuum pump, the HBr/H₂SO₄ aqueous mixture is heated to a temperature in the range from 25-110° C. Owing to the reduced pressure, HBr—H₂O evaporates over that temperature range. A first distillate is formed when the temperature reaches ˜70-80° C., the vapor phase is condensed and collected. Usually distillation is completed when the temperature reaches 100° C. The bromide-free distillation residue is cooled to about 40-50° C. (<1.0% by weight bromide is attainable) and water is added to the distillation residue, so that the aqueous solution formed can proceed to the metal separation step.

It should be noted that the variant illustrated in FIG. 1, Block B involves reduction of elemental bromine evolving at the leaching step to produce hydrobromic acid, and recycling of the hydrobromic acid for use as a leaching agent. As an alternative, bromine vapors can be absorbed in an alkaline solution, e.g., sodium hydroxide, to form bromide and bromate (BrO₃⁻) according to the following reaction equation (5):

3Br₂+6Na⁺+60H⁻→5Br⁻+BrO₃⁻+6Na⁺+3H₂O (6)

The so-formed bromate is an effective precipitation reagent for divalent metals such as Mn²⁺ as discussed below.

Turning now to the separation of the metals from the filtrate collected after the leaching and HBr recovery, it should be noted that the metals can be isolated from the metals-bearing solution by a variety of techniques, namely, isolation by precipitation with the aid of added precipitation reagents optionally under pH adjustment (for example, alkali hydroxide, alkali carbonate, suitable complexing agents); oxidative precipitation (with the aid of an oxidizer such as bromate); or by electrodeposition, e.g., cathodic deposition. Other separation methods based on ion exchange resin with affinity towards specific metals and solvent extraction can also be employed to isolate the individual metals, e.g., separate between the transition metals and the lithium in the recycling of lithium ion batteries.

One major separation method consists of adding a precipitation reagent to the metals-bearing solution (i.e., the filtrate collected after the leaching step). A suitable precipitation reagent may be selected from the group consisting of alkali hydroxide (e.g., NaOH), alkali bicarbonate (e.g., NaHCO₃), alkali carbonate (e.g., Na₂CO₃) and dimethylglyoxime. Under suitable pH adjustment of the metal-bearing solution, the aforementioned reagents were shown to be effective in separating the metals under consideration. The precipitation reagents may be added in a solid form or as aqueous solutions to induce precipitation. The precipitate is then separated by conventional techniques such as filtration, decantation and centrifugation, and the supernatant collected proceeds to the next separation step.

For example, manganese and lithium are separable from one another upon addition of alkali hydroxide (NaOH) or alkali carbonate (Na₂CO₃) to the metal bearing solution, at slightly alkaline pH (7.0≤pH≤9.0), whereby manganese selectively precipitates from the solution while lithium remains in a soluble form. Likewise, cobalt and lithium are separable from one another with the help of sodium hydroxide (e.g., at 7.5≤pH≤9.0); or sodium carbonate (e.g., at 7.5≤pH≤9.0, in particular around pH=8.0) or sodium bicarbonate (e.g., at 7.0≤pH≤8.0).

Some preferred methods for metal separation are described now in more detail in reference to FIG. 1, Block C. Such methods include (i) separation by precipitation with added reagents such as alkali hydroxide, alkali carbonate and complexation agents of the relevant transition metals (ii) separation by electrodeposition of the transition metal and (iii) separation by oxidative precipitation with added oxidizer. FIG. 1, Block C illustrates successive separation of three transition metals in a specific order (Ni→Co→Mn), followed by isolation of lithium. Commercial lithium batteries contain mixed lithium-metal oxide cathode with one transition metal [such as LiCoO₂ (LCO) or lithium LiMn₂O₄ (LMO)], two transition metals [such as Li₂Mn₃NiO₈ (LMNO)] and three transition metals [such as LiNiMnCoO₂ (NMC)]. Accordingly, the separation methods shown in FIG. 1, Block C can be chosen to meet each specific case and the order of steps for the transition metals shown in FIG. 1 may be changed.

As shown in FIG. 1, Block C, separation by precipitation with a chelating agent is well-suited for nickel, e.g., by addition of dimethylglyoxime to the solution to form nickel bis(dimethylglyoximate).

As shown in FIG. 1, Block C, separation by electrodeposition is well-suited for cobalt. In general, electrodeposition of the transition metal (e.g., Co) in an elemental form onto an electrode can be achieved with conventional electrochemical techniques, e.g., (i) galvanostatic method, with constant current density set in the range from, for example, 4*10⁻⁴ to 2.5*10⁻³ A m² (ii) potentiostatic method, at a constant potential set in the range between, for example, −1.5V and 1 V; and (iii) cyclic voltammetry, using either a two or three-electrodes cell configuration. The deposit is obtained in a highly pure form.

For example, electrodeposition of Co⁽⁰⁾ may be performed in a 3-electrode cell configuration, applying conditions similar to those reported by Freitas et al. (supra) where the working electrode to be coated was aluminum foil, platinum served as the counter electrode, and Ag/AgCl/NaCl as a reference electrode. The electrodes are immersed in the metal-bearing solution (pH may be adjusted) and a cathodic potential is applied on the working electrode for cobalt reduction, i.e., either a fixed voltage or variable voltage that is varied linearly with time.

Electrodeposition of the transition metal (e.g. cobalt) from the metal-bearing solution can also be achieved using a flow cell divided into cathodic and anodic compartments. With such configuration, the metal-bearing solution is recirculated through the cathodic side at a suitable rate while an electrolyte solution (e.g., sodium bromide solution) flows through the anodic side. An outline of a flow cell suitable for use in electrodeposition of metals, equipped with reservoirs for holding the respective plating solution and counter electrolyte solution and pumps for recirculating the solutions can be found in a paper by Arenas et al., Journal of The Electrochemical Society, 164 D57-D66 (2017). For example, experimental results reported below indicate that cobalt can be electrodeposited from ˜5.0 wt % Co-containing leachate onto the cathode in a three-electrode flow cell configuration under galvanostatic control where the working electrode (cathode) and anode consist of carbon felts supported onto current collectors in the form of carbon plates (reference electrode was Ag/AgCl), by applying 4*10\hat{ } (−4) to 2.5*10\hat{ } (−3) A m⁻² for at least 60 minutes at room temperature. Electrodes other than carbon felts can also be coated by the electrodeposited cobalt.

As shown in FIG. 1, Block C, separation by oxidative precipitation is well-suited for the recovery of manganese. It can be accomplished with an oxidizing agent such as bromate, namely, a bromate-containing aqueous stream that is added to the metal-bearing solution. As mentioned above, absorbing bromine vapor evolving in the leaching in an alkaline solution leads to bromate formation (an indigenously generated bromate) which can be returned to the process to oxidize divalent manganese to form MnO₂. The pH is adjusted to the preferred range, roughly 3.5≤pH≤5 owing to the alkalinity of the absorption basic solution. The bromate concentration in the returned aqueous stream may vary from 7 to 12 wt %. Hence about 1.1 moles of the indigenously generated bromate stream would be required to oxidize 3 moles of dissolved Mn²⁺. If needed, fresh bromate salts can be added to the indigenously generated bromate stream to meet precipitation requirements yet minimize the volumes of recycled streams. Alternatively, bromate can be supplied in its entirety to the metal-bearing solution in a solid form, i.e., by the addition of commercially available alkali bromate to the metal-bearing solution, or by injecting aqueous solutions made by dissolving commercial salts. The oxidative precipitation of manganese is not limited to the use of bromate and other oxidizing agents, e.g., potassium permanganate, can be used, as shown by reaction equation (7):

3Mn²⁺+2MnO₄₋+2H2O [symbol] 5MnO₂+4H⁺ (7)

Thus, the invention provides a method wherein the isolation of metals from the metal-bearing solution produced after the leaching step (e.g., leaching of particulate cathode material from industrially crushed spent lithium ion batteries) involves at least two, or at least three, or all of the following steps, which can be conducted in any order:

isolating nickel by precipitation, using a first precipitating reagent (especially chelating agent such as dimethylglyoxime); isolating cobalt by electrodeposition, and collecting cobalt from a plated cathode, e.g., carbon cathode;

isolating manganese by oxidative precipitation, using an oxidizer (preferably bromate as described above); and isolating the remainder of lithium by precipitation, using a second precipitating reagent (e.g., water soluble carbonate or carbon dioxide).

Preferably, nickel is the first metal to be isolated. Usually, the remainder of the lithium is the last metal to be isolated. One specific method consists of the following sequence of steps: adding chelating agent such as dimethylglyoxime to the metal-bearing solution to precipitate a nickel complex, e.g., nickel bis(dimethylglyoximate), recovering the nickel complex and collecting Ni-depleted metal bearing solution;

electrodepositing cobalt from the Ni-depleted metal bearing solution, to obtain cobalt deposit onto an electrode surface and collecting Ni, Co-depleted solution;

adding an oxidizer such as bromate to Ni, Co-depleted metal bearing solution to precipitate an oxide of manganese, separating said oxide of manganese and collecting Ni, Co and Mn-depleted metal bearing solution;

adding a second precipitation reagent to the Ni, Co and Mn-depleted metal bearing solution, for example, a water-soluble carbonate or carbon dioxide, to precipitate the remainder of the lithium as lithium carbonate.

The order of steps may be reversed. For example, removal of manganese may take place before the recovery of cobalt, such that cobalt is electrodeposited from Ni, Mn-depleted bearing solution. Procedures illustrating the separation of the transition metals by the techniques described above can be found in WO 2020/031178.

It should be noted that the method described herein can be used for separating lithium and precious metals from mixtures in general, i.e., not only from lithium spent batteries, such as fly ash and catalysts.

### EXAMPLES

Inductively coupled plasma (ICP) was used to determine the metal content in the feedstock and in solution; the ICP instrument was ICP VISTA AX, Varian Ltd or ICP 5110, Agilent Technologies. Recovery percentage (yield) was calculated, e.g., by [M] solution/[M] feedstock×100, where [M] indicates the measured amount of metal M in the solution and the feedstock, respectively.

### Example 1

### Treatment of Black Mass in an Alkaline Solution with Varying Sodium Hydroxide Concentration and Temperature

A series of tests were conducted to investigate the separability of Li from samples of black mass using sodium hydroxide solutions at different concentrations (5% by weight, 10% by weight or 20% by weight NaOH solution) at different temperatures (30° C., 60° C. and 80° C.). Each experiment consisted of gradual addition of 20 grams of the black mass, over a period of ten minutes, to 180 gr of sodium hydroxide solution in a 250 mL Erlenmeyer held at the test temperature, following which the reaction mixture was stirred for three hours at the abovementioned temperatures. After three hours the sample was filtered on a Buchner with 70 mm Whatman filter paper under vacuum conditions. Metal concentrations were analyzed using ICP. The conditions of each of the experiments and percentage yield of the metals are tabulated in Table 1.

TABLE 1

| Solution | pH | Temperature | Al % | Li % | Co % | Mn % | Ni % | F |
|---|---|---|---|---|---|---|---|---|
| 5% NaOH | 13.58 | 30° C. | 23.82 | 22.81 | 0.04 | 0.02 | 0.02 | — |
| 10% NaOH | 13.68 | 30° C. | 26.91 | 25.13 | 0.07 | 0.04 | 0.04 | — |
| 20% NaOH | 13.60 | 30° C. | 28.36 | 25.31 | 0.04 | 0.03 | 0.00 | — |
| 5% NaOH | 13.64 | 60° C. | 30.0 | 22.80 | 0.054 | 0.019 | 0.02 | 70.6 |
| 10% NaOH | 13.61 | 60° C. | 35.4 | 28.30 | 0.034 | 0.022 | 0.027 | 64.1 |
| 20% NaOH | 13.6 | 60° C. | 37.6 | 29.54 | 0.041 | 0.022 | 0.0045 | 56.8 |
| 5% NaOH | — | 80° C. | 42.2 | 15.2 | 0.00 | 0.00 | 0.00 | — |
| 10% NaOH | — | 80° C. | 40.0 | 17.6 | 0.00 | 0.00 | 0.00 | — |
| 20% NaOH | — | 80° C. | 44.9 | 22.5 | 0.00 | 0.00 | 0.00 | — |

The results indicate that transition metals are not affected by the alkaline treatment: Co, Mn and Ni remained in the black mass and were not dissolved in the alkaline solution. In contrast, appreciable removal rates were measured for Al and Li. The trend shown in Table 1 is that Al removal generally increased with increasing temperature and alkali hydroxide concentration, whereas the separability of lithium from the black mass did not benefit from temperature elevation. Comparable Al and Li removal rates were achieved in sodium hydroxide solution under moderate heating.

The black mass contained fluoride compounds (F⁻ may have originated from the LiPF₆ electrolyte or from fluorinated ethylene carbonate). The presence of F⁻ in the leaching step with hydrobromic acid is undesirable, because hydrofluoric acid (byproduct during bromide recovery at high temperatures) may damage the reactor system. It is seen that treating the black mass with an alkaline solution serves an additional goal: removal of fluoride ions [F⁻ was measured potentiometrically with fluoride ion selective electrode (ISE)].

### Example 2

### Pretreatment of Black Mass in an Acidic Solution Followed by Treatment in an Alkaline Solution with Varying Sodium Hydroxide Concentration and Temperature

The series of tests of Example 1 were repeated, but each experiment was preceded by treating the black mass in 25 gr of 24% (% wt) hydrochloric acid solution at room temperature for a short period of time (20-30° C., 10-30 minutes). Next, the mixture was basified by addition of the alkaline solution and the experiment then proceeded as described in Example 1. The conditions of each of the experiments and percentage yield of the metals are tabulated in Table 2.

TABLE 2

| Alkaline | | | | | | | |
|---|---|---|---|---|---|---|---|
| solution | pH | T | Al % | Li % | Co % | Mn % | Ni % |
| 5% NaOH | — | 30° C. | 6.5 | 38.3 | 0.00 | 0.00 | 0.00 |
| 10% NaOH | — | 30° C. | 6.7 | 41.8 | 0.00 | 0.10 | 0.00 |
| 20% NaOH | — | 30° C. | 7.3 | 48.2 | 0.23 | 0.03 | 0.00 |
| 5% NaOH | 13.20 | 60° C. | 3.4 | 28.5 | 0.00 | 0.00 | 0.00 |
| 10% NaOH | 13.44 | 60° C. | 11.3 | 29.2 | 0.01 | 0.02 | 0.00 |
| 20% NaOH | 13.40 | 60° C. | 10.6 | 25.0 | 0.20 | 0.05 | 0.00 |
| 5% NaOH | — | 80° C. | 4.83 | 22.0 | 0.00 | 0.00 | 0.00 |
| 10% NaOH | — | 80° C. | 9.50 | 24.0 | 0.00 | 0.00 | 0.00 |
| 20% NaOH | — | 80° C. | 19.3 | 24.8 | 0.05 | 0.11 | 0.00 |

The results demonstrate that it is possible to enhance Li removal from the black mass in an alkaline solution, if the black mass is pretreated in an acidic environment, and then transferred to the alkaline solution. The effect is unique to Li: the transition metals Co, Mn and Ni were resistant to the combined procedure, whereas Al rate removal was conversely reduced. That is, the combined procedure led to better selectivity towards lithium removal.

### Example 3

### Metal Removal from Black Mass in Ammonium Hydroxide Solution

The experimental procedure of Example 1 was repeated, but this time the alkaline environment was created by ammonium hydroxide. 12.5% by weight and 25.0% by weight NH₄OH solutions were used at room temperature; amounts were as set out in Example 1. The conditions of each of the two experiments and percentage yield of the metals are tabulated in Table 3.

TABLE 3

| Solution | pH | Temperature | Al % | Li % | Co % | Mn % | Ni % |
|---|---|---|---|---|---|---|---|
| 12.5% NH₄OH | 12.9 | 25° C. | 5.54 | 21.6 | 0.92 | 0.00 | 0.84 |
| 25.0% NH₄OH | 13.3 | 25° C. | 3.27 | 18.32 | 0.34 | 0.00 | 0.79 |

It is seen that ammonium hydroxide solution was especially selective towards Li removal from black mass. Moreover, the favorable effect was achieved at room temperature.

### Example 4

### Recovery of Lithium from Sodium Hydroxide Solution

Lithium was recovered from a filtrate obtained following the alkaline treatment and filtration of the black mass (for the alkaline treatment, 200 gr of 20% (% wt) sodium hydroxide solution was used to treat 22 gr of black mass (two samples: one without the acidic pretreatment step (4A) and the other following the acidic pretreatment step (4B), as described in Examples 1 and 2, respectively). The black mass was then separated by filtration from the alkaline aqueous phase.

The filtrate, which in each sample 4A and 4B contained 0.11% (% wt) Li, was treated to recover lithium in the form of Li₂CO₃. To this end, Na₂CO₃ (20 gr) was added to the filtrate, and the solution was heated to 100° C. and stirred for three hours.

After three hours the samples were filtered on a Buchner with 70 mm Whatman filter paper under vacuum. Lithium concentrations were analyzed using ICP. Lithium removal percentage measured for sample 4A (no acidic pretreatment) and 4B (including acidic pretreatment) were 41% and 45%, respectively.

### Example 5 (of the Invention) and 6 (Comparative) Leaching with HBr (of the Invention) or H₂SO₄ (Comparative) of Black Mass after Treatment in Sodium Hydroxide Solution

Black mass sample (30 gr) was treated in 20% (% wt) sodium hydroxide solution at 60° C. as described in Example 1. The treatment was repeated twice. The black mass was then separated from the alkaline solution and added to a 250 mL Erlenmeyer that was previously charged with 120 gr of an acidic solution (either 48% wt HBr or 30 wt % H₂SO₄). The black mass was gradually added over 10 minutes. The temperature during the addition was 60° C.

After the addition was completed the suspension was stirred for three hours. Then the sample was filtered on a Buchner with 70 mm glass-microfiber discs (Sartorius stedim) under vacuum. Recovery % of the metals are tabulated in Table 4 below, indicating recovery % owing to the action of the acidic leach solution, and total recovery % (in parentheses) achieved by the alkaline treatment and the action of the acidic leach solution.

TABLE 4

| Ex. | leachate | Al (%) | Li (%) | Co (%) | Mn (%) | Ni (%) |
|---|---|---|---|---|---|---|
| 5 | HBr | 36.1 (93.5) | 43.0 (85.0) | 98.2 (98.5) | 87.5 (87.6) | 85.8 (85.9) |
| 6 | H₂SO₄ | 18.6 (75.9) | 27.4 (69.7) | 67.6 (67.9) | 57.8 (57.9) | 56.4 (56.5) |

While transition metals were exclusively removed during the leaching step, lithium removal was roughly equally divided between the alkaline treatment and the leaching step. The results also demonstrated that leaching with HBr achieves high removal rates (85-95%) compared to sulfuric acid.

### Example 7

### Leaching of Black Mass with HBr, Ex-Situ Bromine Reduction and HBr Recovery by Distillation

The next example illustrates a leaching procedure of black mass using aqueous HBr 48%, enabling the conversion of elemental bromine (co-product evolving during leaching) back to aqueous HBr, and recovery of pure aqueous HBr by distillation, for further use in a next leaching cycle.

Step 1: Reduction of Elemental Bromine to Produce HBr

Assemble the reactor system, connect the heating system to the reactor jacket and the cooling system to the condenser. The condenser outlet should be connected to two traps.

The first trap is assembled as a back-flash trap.

Fill the second trap with 10% N₂H₄ solution. This trap is used to absorb bromine generated during the reaction and to transform it to HBr.

Add 150 gr HBr 48% (% wt) into a stirred vessel.

Heat the vessel content to 60° C.

When the temperature of the HBr in the vessel reaches 40° C., start adding 37.5 gr LCo based black mass into the reactor. The black mass addition should be slow (duration of about 30 min).

Agitate the vessel content for 3 hours at 60° C.

Bubble air into the reactor content to remove remaining bromine vapors (during 30 minutes).

Cool the mixture to 40° C.

Filter the reactor content upon a glass fiber filter to obtain a filtrate.

Wash the cake with 50 gr distilled water (DW), the wash water should be added to the filtrate.

Dry the filter cake in an oven, T=100° C., under vacuum conditions.

Step 2: Distillation of Aqueous Hydrobromic Acid from Leachate

Assemble the reactor system, connect the heating system to the reactor jacket and the cooling system to the condenser. In addition, connect a distillate receiver to the bottom of the condenser. Connect the condenser outlet to a vacuum pump.

Filtrate obtained by the procedure set out in the previous step (253 gr) was added to the stirred reactor, followed by addition of 40 wt % H₂SO₄ (164.3 gr).

The temperature of the reactor's jacket was raised to 100° C.

The reactor was under vacuum conditions (157 mbar).

When the reactor temperature reached 78° C., the first distillate started to exit the system. The HBr—H₂O mixture was condensed in the distillation receiver. After about two hours the distillation ended, and the reactor temperature was cooled to 40° C. 152 gr of DW were added to the distillation residue.

TABLE 5

| Fraction | Br⁻ , % wt |
|---|---|
| Blank - the stock solution | 23.5 |
| 1^{st} distillate | 9.3 |
| 2^{nd} distillate | 41.4 |
| 3^{rd} distillate | 39.8 |
| Distillation residue | 0.88 |

Total yield: 92%.

In the next set of examples (8A, 8B and 9), during gradual addition of HBr leaching solution to a slurry of the treated black mass in water, a reducing agent was supplied under ORP control to suppress escape of bromine vapors and recycle bromine. The reactor system was based on a stirred reactor fitted with an ORP control. When redox values exceeded a desired value, a solution of the reducing agent was added gradually into the reactor using a prominent dosage pump (Gamma/L).

### Examples 8A and 8B Leaching of Black Mass with HBr and In-Situ Bromine Reduction with Hydrazine

8A: A slurry of 70 gr black mass and 90 gr DW was prepared and added into a 0.5 L reactor. 396 gr 48% (% wt) HBr was slowly added to the slurry (addition time was 50 min). The HBr addition was performed while controlling the reaction ORP value at 780 mv, using 10% (% wt) N₂H₄. A total of 35 grams N₂H₄ solution was needed. ORP electrode used was Mettler Toledo Pt4805-DXK-S8/425. Removal rates are tabulated in Table 6.

TABLE 6

| Ex. | leachate | Al (%) | Li (%) | Co (%) | Mn (%) | Ni (%) |
|---|---|---|---|---|---|---|
| 5 | HBr | 96 | 78.2 | 100 | 100 | 100 |

The results show that the leaching efficiency was not affected by N₂H₄ addition to the leaching reactor.

8B: The experiment was repeated, this time the HBr addition was performed while controlling the reaction ORP value at 750 mv, using 10% (% wt) N₂H₄ solution. A total of 63 grams N₂H₄ solution was needed. ORP electrode used was Pt4805-DPA-SC-S8/425 ORP electrode. Removal rates are tabulated in Table 7.

TABLE 7

| leachate | Al (%) | Li (%) | Co (%) | Mn (%) | Ni (%) |
|---|---|---|---|---|---|
| HBr | 94 | 78 | 100 | 96 | 100 |

The results show that the leaching efficiency was not affected by N₂H₄ addition to the leaching reactor.

### Example 9

### Leaching of Black Mass with HBr and In-Situ Bromine Reduction with Sodium Bisulfite

A slurry of 70.1 gr black mass and 90.6 gr DW was prepared and added into a 0.5 L reactor. 396 gr 48% (% wt) HBr was slowly added to the slurry (addition time was 60 min). The HBr addition was performed while controlling the reaction ORP value at 740 mv, using 15% (% wt) NaHSO₃. A total of 341 grams NaHSO₃ solution was needed. ORP electrode used was Mettler Toledo Pt4805-DXK-S8/425. Removal rates are tabulated in Table 8.

TABLE 8

| leachate | Al (%) | Li (%) | Co (%) | Mn (%) | Ni (%) |
|---|---|---|---|---|---|
| HBr | 95.1 | 75 | 100 | 100 | 100 |

The results show that the leaching efficiency was not affected by NaHSO₃ addition to the leaching reactor.

1. A hydrometallurgical method for recovering lithium and one or more transition metals from spent lithium ion batteries, comprising:
treating an electrode material of the batteries in an alkaline solution to dissolve lithium in said solution;
separating from the alkaline solution a solid phase consisting of lithium-depleted electrode material;
recovering lithium from said alkaline solution;
leaching the lithium-depleted electrode material with an acid leach solution to dissolve one or more transition metals of the electrode material in the leach solution;
separating insoluble material, if present, from the leach solution to obtain metal-bearing aqueous solution and isolating one or more transition metal(s) and optionally the remainder of the lithium from said metal-bearing aqueous solution.

2. A method according to claim 1, wherein the electrode material comprises a cathode material of spent lithium ion batteries selected from the group consisting of lithium cobalt oxide (LiCoO₂), lithium manganese oxide (LiMn₂O₄) lithium manganese nickel oxide (Li₂Mn₃NiO₈) and lithium nickel manganese cobalt oxide (LiNiₓMn_{y}Co_{z}O₂, where X:Y:Z is 1:1:1, 5:3:2, 6:2:2 or 8:1:1).

3. A method according to claim 1 or 2, further comprising a pretreatment step in which the electrode material is disrupted to increase its accessibility to the alkaline solution.

4. A method according to claim 3, wherein the pretreatment step comprises suspending the electrode material in an acidic environment.

5. A method according to claim 4, wherein the pretreatment step is followed by basification with the alkaline solution, or separation of the solid electrode material and its addition to the alkaline solution.

6. A method according to claim 1, wherein the alkaline solution is sodium hydroxide and the treatment temperature is from 30 to 70° C.

7. A method according to claim 1, wherein the alkaline solution is ammonium hydroxide and the treatment temperature is from 20 to 30° C.

8. A method according to claim 1, wherein lithium is recovered from the alkaline solution by precipitation of lithium carbonate.

9. A method according to claim 1, wherein the leach solution comprises hydrobromic acid.

10. A method according to claim 9, comprising reducing elemental bromine (Br₂) formed during the leaching to generate HBr.

11. A method according to claim 10, comprising expelling the elemental bromine as vapors from the leach solution and absorbing said bromine vapors in an aqueous solution of a reducing agent.

12. A method according to claim 10, comprising adding a reducing agent to the leach solution.

13. A method according to claim 10, wherein the reducing agent is selected from the group consisting of hydrazine, elemental sulfur, bisulfite and sulfur dioxide, to generate HBr and optionally H₂SO₄.

14. A method according to claim 10, wherein upon completion of the leaching step, whereby metals-bearing aqueous solution is obtained, hydrobromic acid is recovered by distillation under reduced pressure from said metal-bearing aqueous solution in the presence of H₂SO₄.

15. A method according to claim 1, wherein the metals are isolated from the metal-bearing solution by precipitation, oxidative precipitation, electrodeposition, ion exchange or solvent extraction and their combination.
